(19) United States
(12) Patent Application Publication
(10) Pub. No.: US 2016/0153634 A1
(43) Pub. Date: Jun. 2, 2016

(54) LIGHTING SYSTEM FOR A MOTOR VEHICLE WITH STATIC LIGHT-BEAM SCANNING MEANS

(71) Applicant: Valeo Vision, Bobigny Cedex (FR)

(72) Inventors: Pierre Albou, Paris (FR); Jean-Claude Puente, Livry Gargan (FR); Vincent Godbillon, Paris (FR)

(21) Appl. No.: 14/939,112

(22) Filed: Nov. 12, 2015

(30) Foreign Application Priority Data
Nov. 27, 2014 (FR) 1461589

(51) Int. Cl. F21S 8/10

(52) U.S. Cl. CPC F21S 48/1731; F21S 48/1225

(57) ABSTRACT

A lighting system that includes a light source able to generate a light beam and static means for scanning the light beam incorporating at least one body for deflecting the path of the beam. The static means for scanning the light beam also have optical means for amplifying the deflection of the path of the light beam positioned downstream of the deflection body, in relation to the propagation direction of the light beam.

### CROSS-REFERENCE TO RELATED APPLICATIONS

This application claims priority to the French application 1461589 filed Nov. 27, 2014, which application is incorporated herein by reference and made a part hereof.

### BACKGROUND OF THE INVENTION

1. Field of the Invention

The present invention relates to the technical domain of lighting systems for motor vehicles. More specifically, the invention relates to a lighting system forming a headlamp for a motor vehicle.

2. Description of the Related Art

A motor vehicle headlamp is primarily intended to illuminate the road, and incorporates different optical systems and light sources.

It is known to use a headlamp in two different modes.

The first mode, commonly referred to as “low beam”, generates lighting inclined slightly downwards in order to illuminate approximately 50 meters of the road in front of the vehicle without dazzling any drivers travelling in the opposite direction on the adjacent carriageway. In this operating mode, the driver is better able to see the short-distance environment when travelling at night or in difficult weather conditions (fog, snow, rain).

The second operating mode, commonly referred to as “high beam”, generates high-intensity lighting in front of the vehicle and considerably increases the driver's field of vision, notably at nighttime and when it is snowing or raining. However, the orientation of the light beam is in this case liable to dazzle drivers travelling in the opposite direction on the adjacent carriageway or drivers travelling in front on the same carriageway, and as such it is necessary to switch to low beam when this situation occurs.

It is also known to provide an additional operating mode for the headlamp known as “adaptive driving beam” (ADB) or “selective beam”, which generates “high beam” type lighting that is partially masked to prevent illumination of zones where there are vehicles coming from the opposite direction or vehicles travelling in front. This prevents other drivers from being dazzled while retaining a large field of vision. Document EP-2 415 838 may be referenced for more details on the ADB operating mode.

In this latter operating mode, the “selective beam” is generated by projection of a luminous image formed by scanning a light beam.

To obtain an image of adequate size, scanning must be performed on an angular sector with either a large angle or a large radius. In the latter case (large radius), the optical path is relatively long, so the means for generating the image to be projected are relatively bulky. In consideration of increasingly severe space constraints in the front of vehicles, it is preferable to perform the scanning on an angular sector with a large angle instead of a large radius. The scanning must therefore cover a sufficiently large angular sector, for example around 15°, in order to create a sufficiently large luminous image.

Light-beam deflection devices that include, for example, electro-optical, acousto-optical or mechano-optical means, are already known from the prior art. Some of these means have the advantage of being static, which limits the wear of same when compared to dynamic means. Static means for scanning a light beam including at least one body for deflecting the path of the light beam and means for controlling the deflection body are also already known from the prior art. However, all such devices can only deflect a beam by up to 2°. In particular, the person skilled in the art is discouraged from using static deflection means on account of the low deflection angle that they provide.

Document EP-2 890 352, which is equivalent to U.S. Patent Publication 2014/0029282, proposes overcoming this problem using a scanning system incorporating articulated micro-mirrors that are able to scan a light beam over an adequate angular sector.

However, this system has a number of problems.

The micro-mirrors are mechanically fragile because they are subject to vibration and shocks that could upset the hinge lines of same, or even break same. Furthermore, they are thermally fragile because the reflection coefficient of same is not exactly 100% (it is usually around 90-99%). The micro-mirrors therefore have to absorb a portion of the energy carried by the light beam and the low thermal capacity of same (related to the low volume of same) results in a significant temperature increase that could damage same.

Furthermore, the micro-movements made by the mirrors subject same to fatigue stresses that progressively deteriorate same.

Finally, controlling such a system of micro-mirrors is relatively complex.

### SUMMARY OF THE INVENTION

The invention is intended to provide a lighting system fitted with scanning means forming an image designed to be projected, these scanning means covering a sufficiently large angular sector, using simple static robust means.

For this purpose, the invention proposes a lighting system for a motor vehicle comprising:
a light source able to generate a light beam, and
static means for scanning the light beam including at least one body for deflecting the path of the light beam and means for controlling the deflection body,

characterized in that the static scanning means also have optical means for amplifying the deflection of the path of the light beam positioned downstream of the deflection body, in relation to the propagation direction of the light beam.

Thus, the static means for scanning the light beam make it possible to cover an angular sector of around 2°, and the optical amplification means make it possible to amplify same to achieve a satisfactory angular-sector angle.

The means for adjusting the deflection are static, which means they are not subject to any fatigue stress. Since the elements involved in deflecting the light beam are the deflection body, the means for controlling the deflection body and the optical amplification means, this lighting system is more robust and of simpler design than the lighting system in the prior art comprising micro-mirrors.

In a first embodiment, the deflection body is a reflective body able to reflect the light beam, and the means for controlling the deflection body include means for generating a standing pressure wave in the reflective body, the frequency of this wave being controllable to scan the light beam.

A diffraction grating then appears on the surface of the reflective body, the spacing of which is controlled by the standing pressure wave, which is frequency-controlled. Scanning of the light beam can be controlled by controlling the spacing.

Advantageously, the reflective body has a surface that reflects the light beam and forms a diffraction grating.

As such, the spacing of the existing diffraction grating is varied using the standing pressure wave generated by the means for controlling the deflection body.

According to another embodiment, the deflection body is a transparent body traversed by the light beam, and the means for controlling the deflection body include means for generating a standing pressure wave in the transparent body, the frequency of this wave being controllable to scan the light beam.

Thus, the standing pressure wave causes the uniformity of the refractive index of the transparent body to be lost, the refractive index then having local minima and local maxima corresponding to the nodes and antinodes of the standing pressure wave. The periodic non-uniformity of the refractive index in the transparent body results in a deflection of the light beam. Controlling the frequency of the standing pressure wave makes it possible to control the position of the nodes and antinodes of the wave, and therefore to control scanning of the light beam.

According to another embodiment, the deflection body is a transparent body refracting the light beam, for example a prism, and the means for controlling the deflection body include means for generating a variable electrical field in the transparent refractive body.

Controlling the variation of the electrical field in the transparent body makes it possible to vary the refractive index in the transparent body, and therefore to control scanning of the light beam.

Advantageously, the Kerr constant of the transparent refractive body is greater than 1×10⁻¹² m·V⁻².

The variation in the refractive index of the transparent refractive body, caused by the variation of the electrical field in the transparent body, by means of the Kerr effect, is therefore particularly significant.

Advantageously, the transparent refractive body is a crystal belonging to the trigonal, tetrahedral, hexagonal, triclinic, monoclinic or orthorhombic crystal system.

The transparent body is then birefractive, and the variation of the refractive index of the medium, caused by the variation in the electrical field in the transparent body, also occurs by virtue of the Pockels effect.

According to one embodiment, the optical means for amplifying the deflection of the path of the light beam include a convex mirror, that is for example cylindrical or spherical.

According to another embodiment, the optical means for amplifying the deflection of the path of the light beam include a lens, preferably a diverging lens.

These optical means enable the deflection body to simply and efficiently amplify the scanning of the light beam in order to achieve a satisfactory angular-sector angle.

Advantageously, the lighting system also includes means for absorbing the light beam that are intended to absorb the light beam when the deflection body is in a predetermined idle position.

The invention also proposes a method for securing a lighting system, characterized in that the lighting system is as defined above and in that, when the means for controlling the deflection body are deactivated, the deflection body is moved to the idle position of same.

Thus, when the deflection body is in the idle position of same, the absorption means absorb the light beam in order to prevent deterioration of the lighting system by overheating.

Advantageously, the lighting system also includes means for controlling the light source.

The invention also proposes a method for securing a lighting system characterized in that the lighting system is as defined above and in that, when the means for controlling the deflection body are deactivated, the light source is deactivated using means for controlling this light source.

This prevents deterioration of the lighting system by overheating, in particular if the control means are deactivated in an untimely manner.

These and other objects and advantages of the invention will be apparent from the following description, the accompanying drawings and the appended claims.

### BRIEF DESCRIPTION OF THE ACCOMPANYING DRAWINGS

The invention can be better understood from the description given below, provided exclusively as an example, with reference to the drawings, in which:

FIG. 1 is a schematic view of a lighting system according to a first embodiment of the invention;

FIGS. 2 to 4 are views of a lighting system similar to the one in FIG. 1 according to second, third and fourth embodiments;

FIG. 5 is a simplified view of a lighting system according to the invention; and

FIG. 6 is a larger scale view of the absorption means of the lighting system in FIG. 1.

### DETAILED DESCRIPTION OF THE PREFERRED EMBODIMENTS

With reference to FIG. 1, a lighting system 10 for a motor vehicle, according to a first embodiment of the invention, includes a conventional light source 12. This includes for example a laser diode (not shown) emitting a substantially monochromatic light beam L.

Static scanning means 14 for scanning the light beam are positioned on the path of the light beam L. These static scanning means 14 include a static supporting element 16 rigidly connected to other optical elements of the lighting system 10, notably the light source 12, and a deflection body 18 attached to the supporting element 16. In this case, the deflection body 18 is formed by a metal bar, the reflection coefficient of which is close to 1, such that the loss of optical power in the light beam L by absorption into the bar or deflection body 18 is as low as possible. The inclination of the deflection body 18 enables the light beam L to be deflected by a lateral reflective surface of the deflection body 18.

The deflection body 18 is linked to the supporting element 16 by means of an absorber 20 placed between one extremity 18A of the deflection body 18 and the supporting element 16. As shown below, the orientation of the deflection body 18 and the absorber 20 facilitate operation of the lighting system 10.

The static scanning means 14 also include a deformable body 22 positioned in contact with the other extremity 18B of the deflection body 18. The deformable body 22 is in this case a conventional piezoelectric transducer, for example made of quartz.

The deflection body 18 is therefore positioned between the absorber 20 and the deformable body 22, with the respective extremities 18A and 18B in contact with this absorber 20 and the deformable body 22.

A control means 24 for controlling the deflection body 18 are connected to the piezoelectric transducer or deformable body 22. These control means 24 make it possible to control the current supplied to the piezoelectric transducer or deformable body 22 by a power source (not shown), for example the battery of the vehicle in which the lighting system 10 is mounted.

When the control means 24 for controlling the deflection body 18 are deactivated, i.e. when they determine the supply of a zero current to the piezoelectric transducer or deformable body 22, the deflection body 18 occupies a predetermined position referred to as the idle position.

A second control means 26 are connected to the light source 12 and to the control means 24. When these latter are deactivated, such that the deflection body 18 occupies the idle position of same, the second control means 26 detect this idle positioning and deactivate the light source 12. The lighting system 10 is thus secured.

The static scanning means 14 also have optical amplification means 28 for amplifying the deflection of the path of the light beam L positioned downstream of the deflection body 18, in relation to the propagation direction of the light beam L. These optical amplification means 28 are in this case formed by a cylindrical convex mirror 29, but may alternatively be formed by a spherical convex mirror or by a lens, preferably a diverging lens. These optical amplification means 28 make it possible to deflect the light beam L emitted by the light source 12 for a second time. In an example embodiment, the cylindrical convex mirror 29 may have a radius of curvature of 25 mm. As detailed below, the geometric properties of the optical amplification means 28 are particularly suited to the intended use of same.

Conventional absorption means 30 are positioned on the optical path of the light beam L, downstream of the static scanning means 14. These absorption means 30 are positioned to absorb the light beam L when the deflection body 18 is in the idle position of same, the light beam L not encountering the absorption means 30 when the control means 24 are controlling the current supplied to the piezoelectric transducer or deformable body 22. This obviates all risk of deterioration caused for example by overheating of the elements of the lighting system 10 in the event of failure of the control means 24 and extended exposure of these elements to the light beam L,

In an example embodiment provided with reference to FIG. 8, these absorption means 30 include a box 300 having a cavity 301 and an opening 302. The wails of the cavity 301 are covered with an absorbent coating 303, for example a matte black diffusing paint or by anodizing. When the deflection body 18 is in the idle position of same, the beam L enters the cavity 301 through the opening 302. It impacts the back wail of the box 300 and is essentially absorbed by the absorbent coating 303. The low proportion of reflected light is diffused in the box 300 where it is essentially absorbed by the absorbent coating 303. Only a minute proportion of the light is liable to leak back out of the opening 302.

Operation of the lighting system 10 is described below.

The light source 12 emits a monochromatic light beam L towards the static scanning means 14. In particular, the light beam L is reflected by the deflection body 18. The control means 24 control the current supplied to the piezoelectric transducer or deformable body 22 to cause an oscillating deformation therein.

By deforming in this way, the piezoelectric transducer or deformable body 22 transmits a standing pressure wave to the deflection body 18. Since this latter is positioned between firstly the piezoelectric transducer or deformable body 22, which is subject to oscillating deformations, and secondly the absorber 20 attached to the supporting element 16, the pressure wave results in the formation of a diffraction grating on the lateral reflective surface of the deflection body 18, the spacing of which is equal to the spatial period of the standing pressure wave, i.e. the space between successive antinodes and nodes of the standing pressure wave. The spacing of the diffraction grating is therefore a function of the frequency of the pressure wave.

Since the diffraction angle is a function of the spacing of the diffraction grating, the control means 24 for controlling the deflection body 18 are therefore means for generating a standing pressure wave in the deflection body 18, the frequency of this wave being adjustable to scan the light beam L.

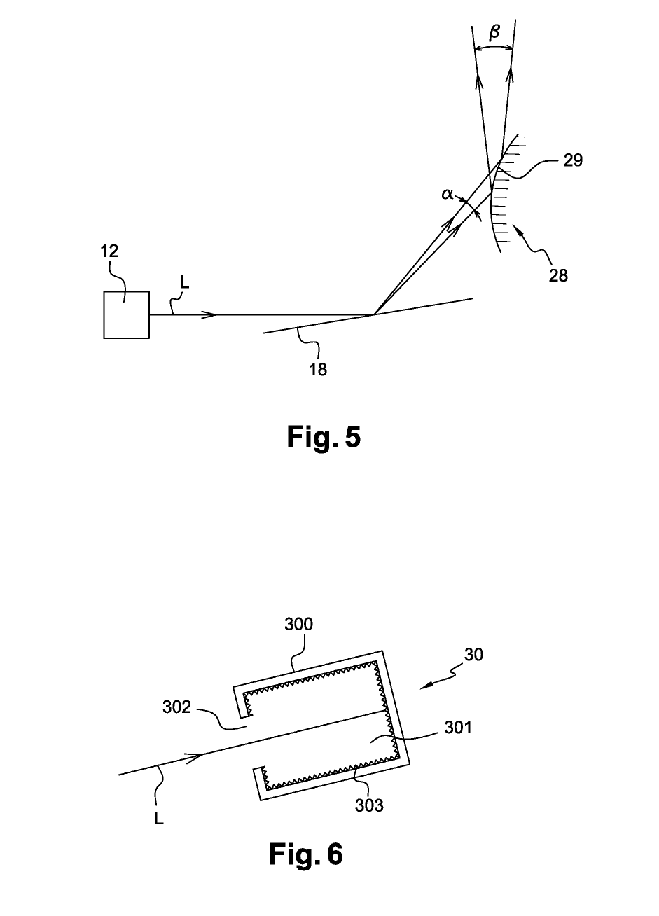

With reference to FIG. 5, the light beam L is scanned in a first non-null angular sector a by diffraction on the deflection body 18, the diffraction angle being controlled by controlling the frequency of the standing pressure wave using the control means 24. In an example embodiment, using a conventional piezoelectric transducer or deformable body 22 and conventional control means 24, the angle α of the first angular sector is around 1.5°.

The light beam L is then propagated as far as the cylindrical convex mirror 29. The curvature of this latter amplifies the deflection of the light beam L, which is then scanned over a second angular sector β. With a cylindrical convex mirror 29 with a radius of curvature of 25 mm and a distance travelled by the light beam L between the reflective body 18 in idle position and the cylindrical convex mirror 29 of around 35 mm, the angle β of the second angular sector is around 15°.

The light beam L is then propagated as far as a known wavelength conversion device (not shown), for example containing phosphorus. This latter then forms a white luminous image resulting from the scanning of the monochromatic light beam L. The luminous image is then projected by known projection means (not shown) such as to emit the light towards a space to be illuminated.

To ensure the safety of the lighting system 10, in particular with regard to unforeseeable operating incidents, when the control means 24 are deactivated, the deflection body 18 is moved to the idle position of same, and the light source 12 is deactivated using the second control means 26 for controlling the light source 12.

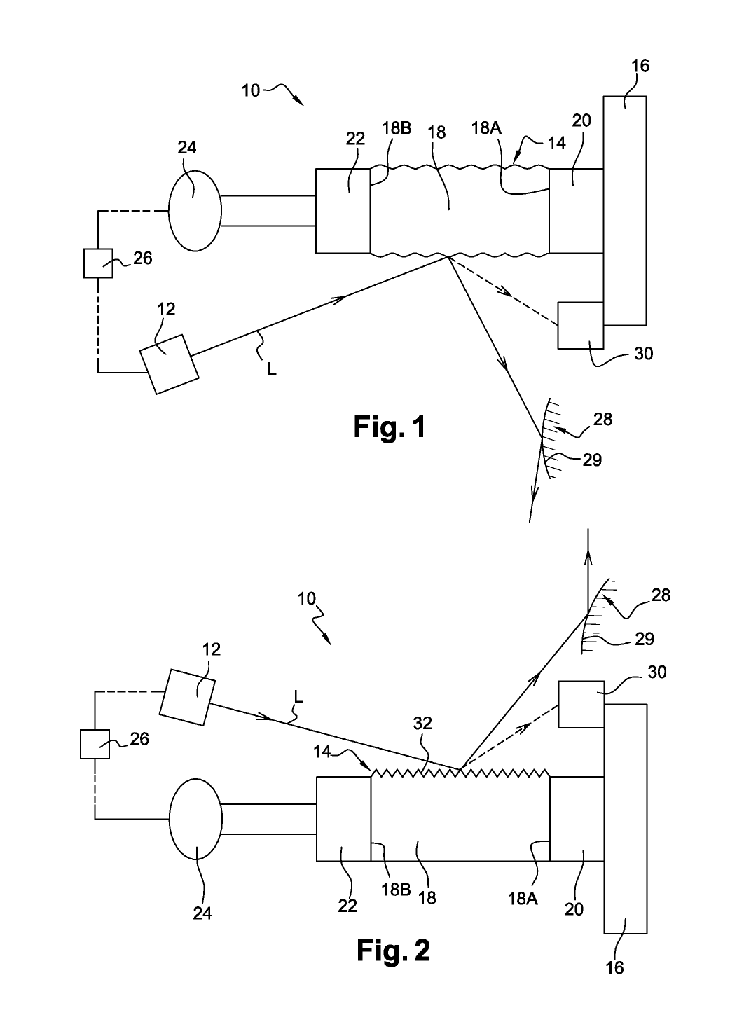

Other embodiments of the lighting system 10 according to the invention are described below with reference to FIGS. 2 to 4. In FIGS. 2 to 4, the elements similar to FIGS. 1 and 5 are identified using identical reference signs.

FIG. 2 shows a second embodiment of the lighting system 10 according to the invention that differs from the first embodiment in that the deflection body 18 is a reflective body with a surface 32 that reflects the light beam and forms a diffraction grating. The effect of the standing pressure wave is therefore to modify the spacing of this existing diffraction grating such as to modify the diffraction angle of the light beam. The light beam L is then scanned by the static scanning means 14.

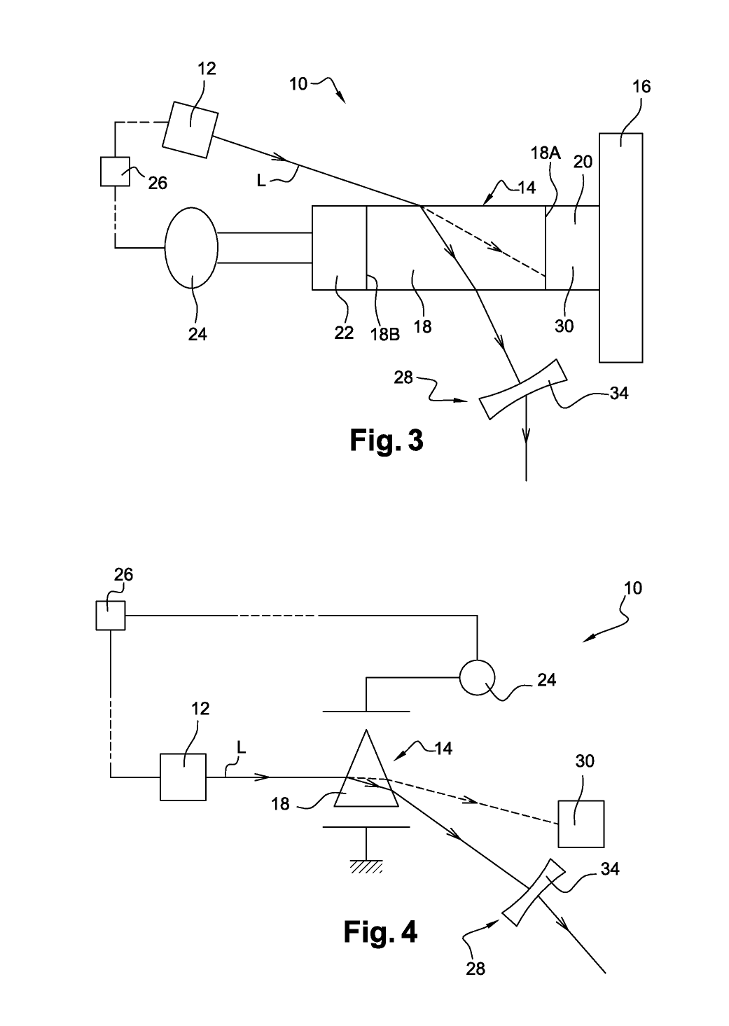

FIG. 3 shows a third embodiment of the lighting system 10 according to the invention, differing from the embodiments previously disclosed in that the deflection body 18 is in this case a transparent body traversed by the light beam L. The control means 24 for controlling the deflection body 18 still include means for generating a standing pressure wave in the transparent body 18, the frequency of this wave being controllable to scan the light beam L.

The standing pressure wave causes the uniformity of the refractive index of the transparent body 18 to be lost, the refractive index then having local minima and local maxima corresponding to the nodes and antinodes of the standing pressure wave. The non-uniformity of the refractive index in the transparent body 18 results in continuous controlled refraction of the light beam L being propagated in the transparent body 18. Controlling the frequency makes it possible to control the position of the nodes and antinodes of the wave, and therefore to control scanning of the light beam L.

In this embodiment, the optical amplification means 28 for amplifying the deflection of the light beam L are a diverging lens 34, and the absorber 20 forms the absorption means 30. The lighting system 10 may nonetheless include absorption means 30 other than the absorber 20.

FIG. 4 shows a fourth embodiment of the lighting system 10 according to the invention, differing from the other embodiments in that the deflection body 18 is a transparent body that refracts the light beam, in this case a prism, and in that the control means 24 for controlling the deflection body 18 include conventional means for generating a variable electrical field in the transparent refractive body 18.

Controlling the intensity of the electrical field created in the transparent refractive body 18 makes it possible to modify the refractive index of same by means of the Kerr effect, and oscillations in the intensity of the electrical field result in scanning of the refracted light beam. To ensure that this change of index is significant, such as to ensure scanning over an angular sector with an angle of around 1°, the transparent refractive body 18 has a Kerr constant greater than 1×10⁻¹² m·V⁻². In an example embodiment, the transparent refractive body 18 may be formed by a glass cell containing nitrobenzene, the Kerr constant of which is approximately 4.4×10⁻¹² m·V⁻².

The transparent refractive body 18 may also be a crystal belonging to the trigonal, tetrahedral, hexagonal, triclinic, monoclinic or orthorhombic crystal system, such that the transparent refractive body 18 is birefractive. Controlling the intensity of the electrical field created in the transparent refractive body 18 thus also modifies the refractive index of same by means of the Pockels effect, such as to accentuate refraction of the light beam L and to accentuate the angle of the angular sector scanned. In an example embodiment, the transparent refractive body 18 may include lithium niobate, the crystal structure of which is trigonal.

Naturally, numerous modifications may be made to the invention without thereby moving outside the scope of same.

Control of the light beam L may include a feedback loop to improve operational reliability of the lighting system 10.

Optical amplification means 28 comprising either a convex, cylindrical or spherical mirror, or a converging or diverging lens may be used in any of the embodiments.

The optical amplification means 28 for amplifying the deflection of the path of the light beam L may include a concave mirror, which has the advantage of reversing the images, for example between the right and left of the light beam L.

Furthermore, a single control program for the first control means 24 for a left-hand headlamp and for a right-hand headlamp of the motor vehicle may be used.

The absorption means 30 may simply comprise a wall covered with black matte paint, notably when these are distinct from the absorber 20.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A lighting system for a motor vehicle, comprising:
a light source able to generate a light beam (L); and
static scanning means for scanning said light beam including at least one deflection body for deflecting a path of said light beam and control means for controlling said at least one deflection body;
wherein said static scanning means also have optical means for amplifying the deflection of said path of said light beam, positioned downstream of said at least one deflection body, in relation to a propagation direction of said light beam (L).

2. The lighting system according to claim 1, wherein said at least one deflection body is a reflective body able to reflect said light beam (L), and in that said control means for controlling said at least one deflection body include means for generating a standing pressure wave in said reflective body, the frequency of said wave being controllable to scan said light beam (L).

3. The lighting system according to claim 2, wherein said reflective body has a surface that reflects said light beam and forms a diffraction grating.

4. The lighting system according to claim 1, wherein said at least one deflection body is a transparent body traversed by said light beam, and in that said control means for controlling said at least one deflection body include means for generating a standing pressure wave in said transparent body, the frequency of said wave being controllable to scan said light beam.

5. The lighting system according to claim 1, wherein said at least one deflection body is a transparent refractive body refracting said light beam, for example a prism, and in that said control means for controlling said at least one deflection body include means for generating a variable electrical field in said transparent refractive body.

6. The lighting system according to claim 5, wherein the Kerr constant of said transparent refractive body is greater than 1×10⁻¹² m·V⁻².

7. The lighting system according to claim 5, wherein said transparent refractive body is a crystal belonging to the trigonal, tetrahedral, hexagonal, triclinic, monoclinic or orthorhombic crystal system.

8. The lighting system according to claim 1, wherein said optical means for amplifying said deflection of said path of said light beam include a convex mirror, that is for example cylindrical or spherical.

9. The lighting system according to claim 1, wherein said optical means for amplifying said deflection of said path of said light beam include a lens, preferably a diverging lens.

10. The lighting system according to claim 1, said lighting system also including means for absorbing said light beam that are intended to absorb said light beam when said at least one deflection body is in a predetermined idle position.

11. A method for securing a lighting system, wherein said lighting system is as claimed in claim 10, and in that, when said control means for controlling said at least one deflection body are deactivated, said at least one deflection body is moved to an idle position of same.

12. The lighting system according to claim 1, said lighting system also including control means for controlling e said light source.

13. A method for securing a lighting system, wherein said lighting system is as claimed in claim 12, and in that, when said control means of said at least one deflection body are deactivated, said light source is deactivated using said control means of said light source.

14. A method for securing a lighting system having means for absorbing a light beam that are intended to absorb the light beam when at least one deflection body is in a predetermined idle position, said method comprises the step of:
deactivating a light source using control means when control means of the at least one deflection body are deactivated.

15. A lighting system for a motor vehicle, comprising:
a light source able to generate a light beam (L); and
a static scanner for scanning said light beam including at least one deflection body for deflecting a path of said light beam and a controller for controlling said at least one deflection body;
wherein said static scanner also has an optical amplifier for amplifying the deflection of said path of said light beam, positioned downstream of said at least one deflection body, in relation to a propagation direction of said light beam (L).

16. The lighting system according to claim 15, wherein said at least one deflection body is a reflective body able to reflect said light beam (L), and in that said controller for controlling said at least one deflection body include a generator for generating a standing pressure wave in said reflective body, the frequency of said wave being controllable to scan said light beam (L).

17. The lighting system according to claim 16, wherein said reflective body has a surface that reflects said light beam and forms a diffraction grating.

18. The lighting system according to claim 15, wherein said at least one deflection body is a transparent body traversed by said light beam, and in that said controller for controlling said at least one deflection body include a generator for generating a standing pressure wave in said transparent body, the frequency of said wave being controllable to scan said light beam.

19. The lighting system according to claim 15, wherein said at least one deflection body is a transparent refractive body refracting said light beam, for example a prism, and in that said controller for controlling said at least one deflection body include a generator for generating a variable electrical field in said transparent refractive body.

20. The lighting system according to claim 19, wherein the Kerr constant of said transparent refractive body is greater than 1×10⁻¹² m·V⁻².

21. The lighting system according to claim 19, wherein said transparent refractive body is a crystal belonging to the trigonal, tetrahedral, hexagonal, triclinic, monoclinic or orthorhombic crystal system.

22. The lighting system according to claim 15, wherein said optical amplifier for amplifying the deflection of said path of said light beam include a convex mirror, that is for example cylindrical or spherical.

23. The lighting system according to claim 15, wherein said optical amplifier for amplifying the deflection of said path of said light beam include a lens, preferably a diverging lens.

24. The lighting system according to claim 15, said lighting system also including an absorber for absorbing said light beams that are intended to absorb said light beam when said at least one deflection body is in a predetermined idle position.
